(19) United States
(12) Patent Application Publication
(10) Pub. No.: US 2004/0078380 A1
(43) Pub. Date: Apr. 22, 2004

(54) Chinese input system with categorized database and method thereof

(76) Inventors: Say-Ling Wen, Taipei (TW); Zechary Chang, Taipei (TW); Leger Wu, Beijing (CN)

Correspondence Address: BIRCH STEWART KOLASCH & BIRCH, PO BOX 747, FALLS CHURCH, VA, 22040-0747, US

(21) Appl. No.: 10/273,126

(22) Filed: Oct. 18, 2002

(51) Int. Cl. G06F 17/00; G06F 7/00

(52) U.S. Cl. 707/101

(57) ABSTRACT

An input system and method with a categorized database that classifies and stores sentences according to different classifications and attributes, enabling a user to accurately locate sentences and improve input speed. The invention further provides a simplified integral administrative operation interface for a user to process inserting, deleting, and instantly updating sentences at any time.

### BACKGROUND OF THE INVENTION

1. Field of the Invention

The invention relates to an input system and method, and particularly a kind of input system and method with a built-in categorized sentence database that enables users to enhance the accuracy of searching for sentences and improve the speed of inputting.

2. Related Art

The biggest problems of an input method are slow input speed and inconvenience. Generally, most input methods that focus on resolving the input speed problem have been developed with the function of disassembling words to achieve the object of increasing input speed. However, before a user can truly increase his/her input speed, s/he has to spend much time self-training and becoming familiar with one method of disassembly. It is too difficult and inconvenient to learn to use such a disassembled input method, and people will not be interested in using it.

Some input methods aim to resolve both problems of input speed and inconvenience by establishing a built-in sentence database. This kind of solution enables a user to achieve the objects of speedy input by directly selecting a sentence from a built-in database without repetitious inputting. However, as most of the stored sentences in such a built-in database are limited in number and with restrictive attributes, it is doubtful that such a built-in sentence database can satisfy the requirements of different users under various situations. Furthermore, if a built-in sentence database cannot serve a user in most cases, it cannot truly enhance the input speed of the user. Though there are many input methods providing built-in sentence databases that enable users to expand or remove sentences by themselves, those input methods do not classify stored sentences, so that users cannot optimize the sentences and re-use them in the database. Another case is that users do not get the point to find some specific sentences of one categorization. Besides the inconvenience mentioned above, the requirement of additional programs to execute the data expansion/removal functions in those input methods is also a drawback. Thus, this kind of sentence database is inconvenient, inflexible, and reduces a user's interest in using the database expansion function.

### SUMMARY OF THE INVENTION

In view of the foregoing, the invention aims at resolving the above-mentioned problems to propose an input system and method with a categorized sentence database function. The main object of the invention is to enhance the accuracy of sentence searching in the database and improving the input speed of a user by applying the characteristics of associated database to establish the categorized sentence database. The categorization sentence database hereinafter is categorized according to different sentence categories and attributes.

The secondary object of the invention is to increase the convenience of using the categorized sentence database by providing the function of adjustable sentence items, a categorized sentence database, and an administrative operation interface for users.

The detailed description and technology of the invention is depicted by the following figures and descriptions.

### BRIEF DESCRIPTION OF THE DRAWINGS

FIG. 1 shows a systematic structure of the input system and method with categorized sentence database function;

FIG. 2 shows an operational flowchart of sentence administration according to the disclosed system and method;

FIG. 3 shows an input flowchart of sentence categorization according to the disclosed system and method;

FIGS. 4-a, 4-b show administrative operations of sentence administration and operation according to the disclosed system and method;

FIG. 5-a shows an initial interface screen of the disclosed system and method; and

FIG. 5-b shows a classified input screen of the disclosed system and method.

### DETAILED DESCRIPTION OF THE INVENTION

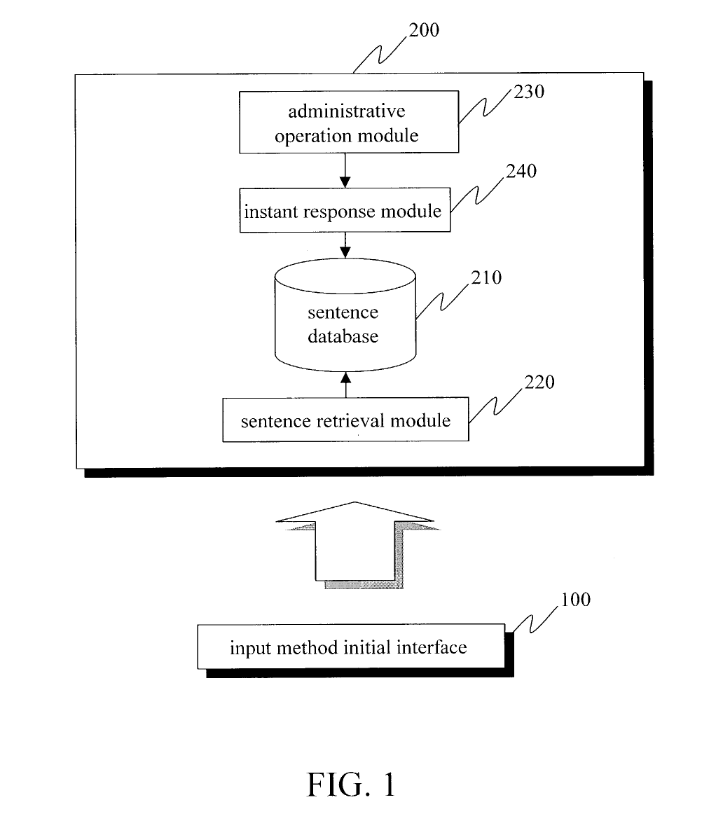

The present invention proposes an input system and method with a categorized sentence database function. The systematic structure of the input system and method as shown in FIG. 1 is described as follows.

(1) The sentence database 210 is mainly for storing a sentence categorization checklist and classified sentences (i.e. sentences built into the system and sentences inputted by users). The sentence database 210 is an associated database that records sentence category numbers corresponding to its category names, and establishes associated indexes between the sentence categorization checklist and its classified sentences. The sentence categories in the invention utilize a hierarchical structure (the same as sentence category numbers) for categorizing each sentence name according to its definition ranges. For instance, under the “LIVING” category, are sub-categories such as “WORKING”, “FAMILY”, “ENTERTAINMENT”, etc., and under those sub-categories are more detailed sub-categories. While there are no more sub-categories to be classified, there are associated sentence contents to be stored. Therefore, when processing sentence searching, the user is able to find required data content with accuracy and efficiency through this hierarchical structure.

(2) The sentence retrieval module 220 is mainly for a user to retrieve corresponding classified sentences from the sentence database 210. In general, any sentence categorization or its classified sentences can be selected through a phonetic identification input-method or a peripheral device input-method. The user is therefore able to instantly retrieve classified sentence content as required from candidate sentence numbers displayed in sentence selector columns.

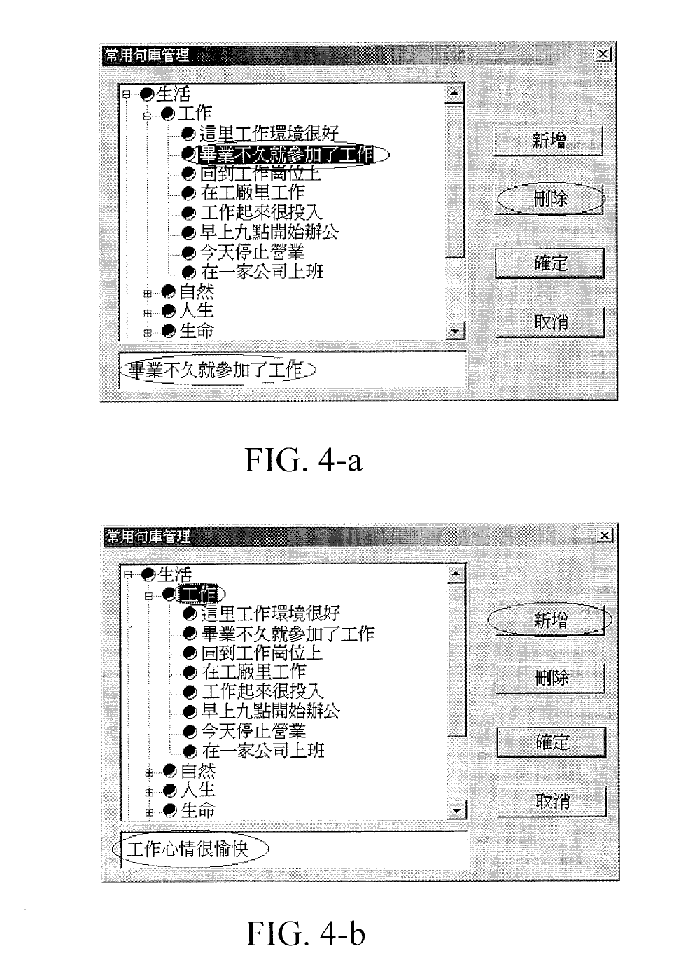

(3) The administrative operation module 230 mainly provides a simplified sentence administrative operation interface for accepting a user's input, and enables the user to insert sentences into and deleting sentences from the sentence categorization and the classified sentences during the input operation. The sentence administrative operation interface comprises a tree structural display area, a sentence input area, and a function key implementation area (as shown in FIGS. 4-a and 4-b). The tree structural display area enables the user to clearly see the status of sentence categorization and classified sentences stored in each category. The sentence input area enables the user to input a sentence categorization name and classified sentences during the insertion operation. The function key implementation area (including insert, delete, confirm, cancel, etc.) is to confirm and implement related functions.

(4) The instant response module 240: when a user completes an operation and chooses to implement a function, the instant response module 240 instantly updates the database, including the sentence database 210 (i.e. sentence categorization and classified sentences) and the sentence administrative operation interface (i.e. the tree structural display area).

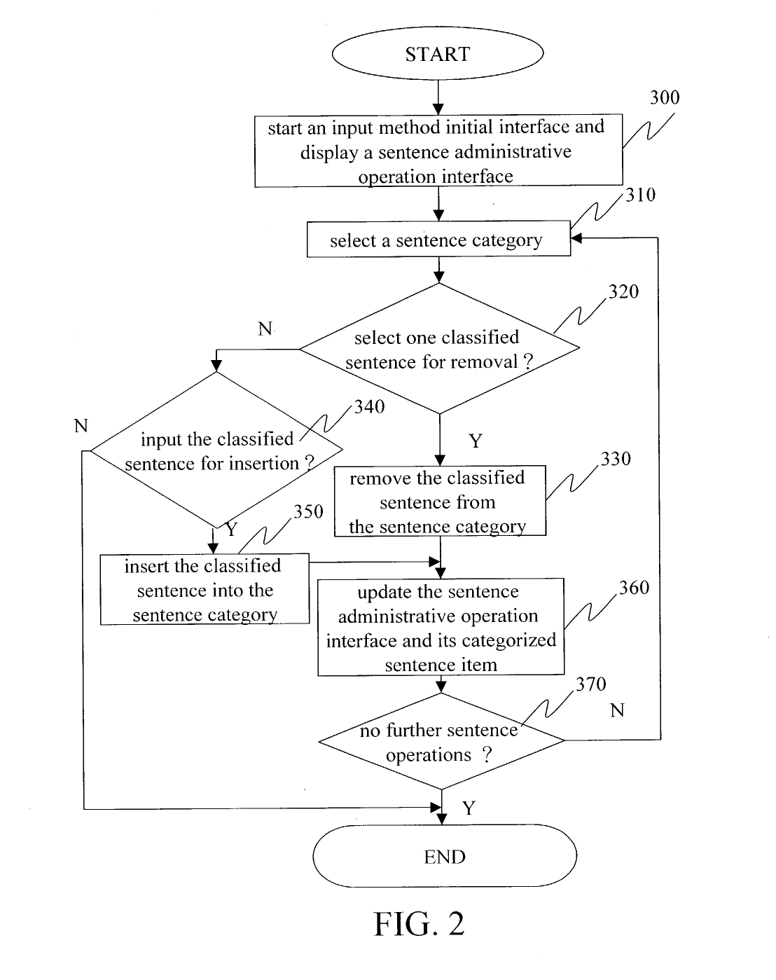

With reference to FIG. 2, the operational flowchart of sentence administration according to the disclosed system and method, the main operational flow of processing sentence administration is described as follows.

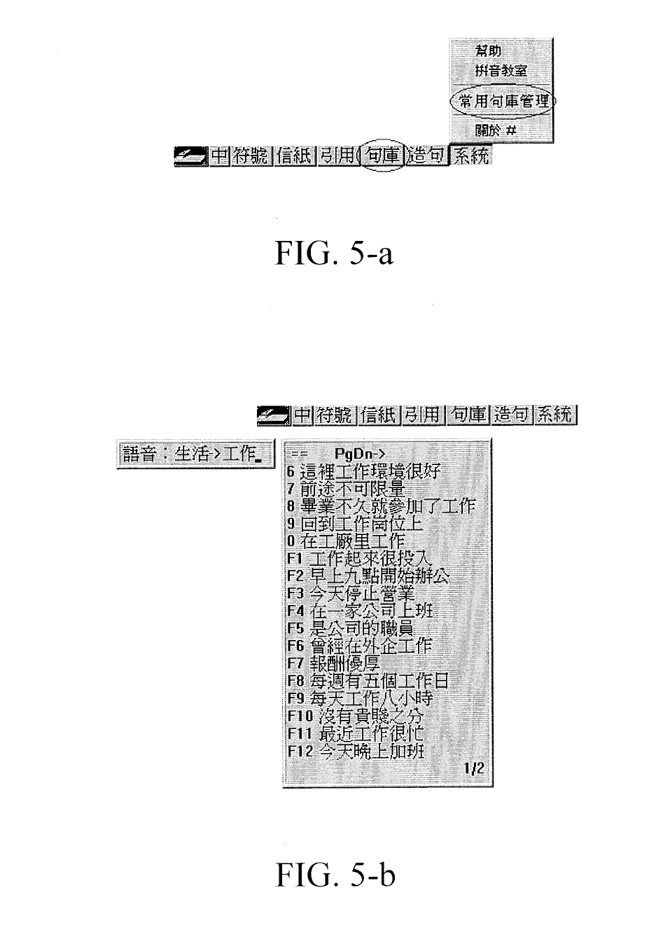

First, a user has to start up an input-method initial interface 100 (as shown in FIG. 5-a), select the function to display the sentence administrative operation interface (step 300), and select a specific sentence category from the screen (step 310). The system then verifies whether the user selects a specific classified sentence from the categorization and simultaneously selects the sentence removal function (as shown in FIG. 4-a) (step 320). If YES, the input system 200 further removes the specific classified sentence from the sentence categorization (step 330), and updates the sentence administrative operation interface and categorized sentence item (step 360). If NO, the input-method system 200 verifies whether the user wants to input a new classified sentence in the sentence-input area, and selects the insertion function (step 340). If NO, then the user does not want to proceed with the sentence administrative operation, and the system then ends the flow; otherwise, the input system 200 stores the classified sentence into the corresponding sentence category (step 350), and updates the sentence administrative operation interface and categorized sentence item (step 360). The input system 200 then asks if the user wants to continue with sentence administrative operations. If NO, the system ends the sentence administrative operation flow.

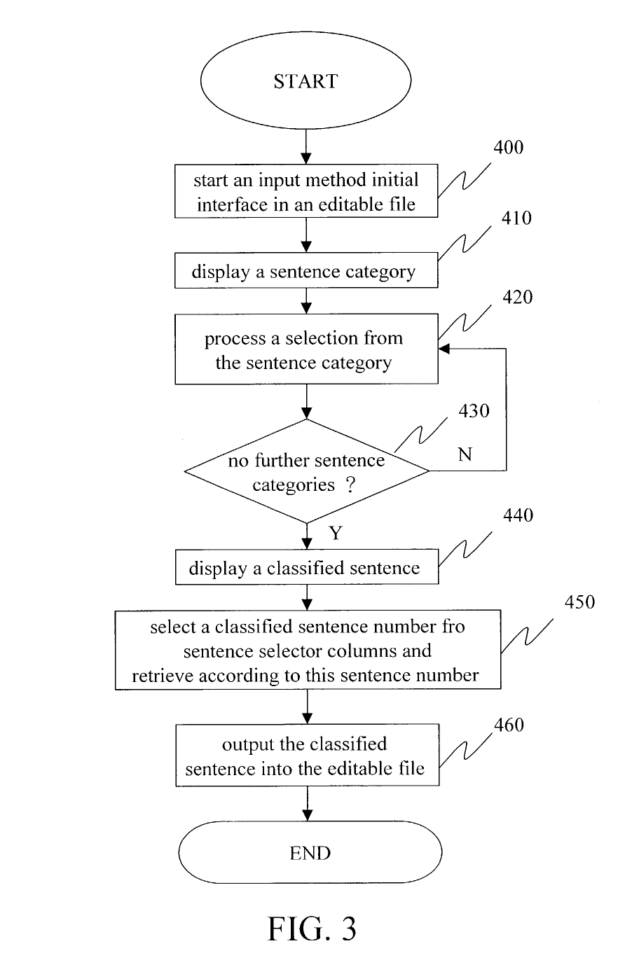

An input flowchart of sentence categorization according to the disclosed system and method is shown in FIG. 3. The main flow of the operation is depicted as follows.

First, a user has to start up the input-method initial interface 100 (as shown in FIG. 5-a) (step 400), and choose to enter into the function of a sentence category, which is displayed by the system (step 410). The user then is able to select a required sentence categorization from candidate sentence numbers displayed in sentence selector columns on the screen through phonetic identification or peripheral device input (step 420). The system verifies whether there are other sentences sub-categorizations (step 430). If YES, the flow goes back to step 420 and the system displays the next level of the sentence category. If NO, classified sentences under the sentence categorization are displayed (as shown in FIG. 5-b, displaying all classified sentences of “WORKING” under the category “LIVING”) (step 440). The user then is able to select a candidate sentence number in sentence selector columns by the same input methods as mentioned above, and the system retrieves corresponding classified sentence though the number from the sentence database 210 (step 450). Finally, the classified sentence is automatically outputted into the editable file (step 460), and the input operation ends.

### Achievements of the Invention

The input system and method with a categorized sentence database function makes the sentence database easier to manage and convenient to use, and enables users to establish a personalized sentence database according to their own usage habits.

The invention further allows a user to quickly search the database and easily find required sentences through hierarchical sentence classifications in the sentence database, so it is more accurate and efficient for a user to search for sentences.

In addition, it saves time for a user to select sentences through phonetic identification input or peripheral device input, and quick selection of sentence numbers greatly heightens the user's input speed.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An input system with categorized sentence database, that classifies and stores sentences according to classifications and attributes, thereby enabling a user to heighten accuracy of searching a sentence and improving the speed while inputting sentences, comprising:
a sentence database for store a sentence categorization checklist and classified sentences;
a sentence retrieval module to retrieve a corresponding classified sentence according to the user's selection from the sentence database;
an administrative operation module for enabling the sentence categorization and the classified sentence to be inserted and removed from the database through a sentence administrative operation interface, which is used to receive a user's operation; and
an instant response module for instantly responding a user's operation and updating the sentence database.

2. The system of claim 1, wherein the sentence categorization checklist further comprises a categorized sentence number and a categorized sentence name.

3. The system of claim 1, wherein the sentence database is an associated database, which establishes associated indexes between the sentence categorization checklist and the classified sentence items.

4. The system of claim 1, wherein the user's selection can be proceeded through input methods such as phonetic identification or through input-method peripheral devices.

5. The system of claim 1, wherein the sentence administrative operation interface further consists of a tree structural display area, a sentence input area, and a function key implementation area.

6. A kind of input method and system with categorized sentence database function, that classifies and stores sentences according to different classifications and attributes, enables a user to heighten accuracy of searching a sentence and improve the speed while inputting sentences. The method consists of the following steps,
starting an input-method initial interface to display a sentence administrative operation interface;
selecting one sentence category;
inserting/deleting a classified sentence; and
updating the sentence administrative operation interface and its categorized sentence item.

7. The method of claim 6, wherein the sentence administrative operation interface further consists of a tree structural display area, a sentence input area, and a function key implementation area.

8. The method of claim 6, wherein the sentence category provides a categorized sentence number by hierarchal numbering rule based on the definition range of a sentence categorization name.

9. The method of claim 6, wherein the method further consists of the step of inserting/deleting the sentence category.

10. A kind of input method and system with categorized sentence database function, that classifies and stores sentences according to different classifications and attributes, enables a user to heighten accuracy of searching a sentence and improve the speed while inputting sentences. The method consists of the following steps,
starting an input-method initial interface in an editable file;
displaying a sentence category;
proceeding the sentence category selection;
displaying a classified sentence;
retrieving a classified sentence from sentence selector columns through selecting its classified sentence number from sentence selector columns by a user; and
outputting the classified sentence into the editable file.

11. The method of claim 10, wherein the sentence category provides a categorized sentence number by hierarchal numbering rule based on the definition range of a sentence categorization name.

12. The method of claim 10, wherein the operation of selecting its classified sentence number can be inputted through either phonetic identification or peripheral devices.
